(19) United States
(12) Patent Application Publication
(10) Pub. No.: US 2026/0336433 A1
(43) Pub. Date: Oct. 29, 2026

(54) MODULAR BATTERY SYSTEM FOR AN ELECTRIC BOAT

(71) Applicant: EXCEL INDUSTRIES, EPERNAY (FR)

(72) Inventor: Cyril BALLU, LA MADELEINE (FR)

(73) Assignee: EXCEL INDUSTRIES, EPERNAY (FR)

(21) Appl. No.: 19/111,519

(22) PCT Filed: Oct. 20, 2023
(86) PCT No.: PCT/EP2023/079222

§ 371 Date: Mar. 13, 2025

(30) Foreign Application Priority Data
Nov. 14, 2022 (FR) 2211791

(51) Int. Cl. B60L 50/60; B60L 50/64; B60L 58/12; B60L 58/21; B63B 3/38

(52) U.S. Cl. CPC B60L 50/66; B60L 50/64; B60L 58/12; B60L 58/21; B63B 3/38; B60L 2200/32; B60L 2240/547; B60L 2260/26; B63B 2003/382

(57) ABSTRACT

The present invention relates to a boat (1) comprising: a shell (10); a casing (12) in which a plurality of racks (14) are arranged; a plurality of extractable batteries (16) adapted to be plugged into the racks (14) of the casing (12); a control module (18) configured to control the power supplied to items of electrical equipment (20) on the boat (1) from the batteries (16); the batteries (16) of the plurality of batteries (16) being controlled to supply power to the items of electrical equipment (20) sequentially, one after the other, or in combination, several batteries (16) simultaneously supplying power according to a selectable operating mode from among an economical operating mode, a manoeuvring operating mode and a supercharged operating mode.

### TECHNICAL FIELD

The present invention relates to the field of electric or hybrid propulsion boats, and more particularly to a modular battery system.

### BACKGROUND

As with all resources carried on board a ship for the maritime transport of people or goods, energy on board a vessel presents major constraints on its on-board management, whether for the collection of systems contributing to the navigation or safety of the craft, or for passenger comfort systems. It is known for this to be done by electrical equipment powered by a set of on-board batteries.

On the other hand, in the case of a sailboat, the intermittent propulsion provided by wind power is often compensated by secondary mechanical propulsion using a motor, by converting stored on-board energy in the form of fuel or a battery. A sailboat motor is also generally used for maneuvering in port or for anchoring.

Hybrid-electric sailboats have been known to combine the electric motor and the battery system to power the boat's electrical equipment. The batteries then supply electrical energy simultaneously not just to an electric motor to ensure the boat's propulsion, but also to all the electrical equipment. It is therefore known to use as an electric motor a reversible electric machine configured to recharge the battery pack by driving the propeller, during sailing phases when the sailboat is propelled by the force of the wind. The electric motor is then in “hydro-generator” mode.

Despite the possibility of recharging the battery pack with a hydro-generator, wind propulsion is by its very nature intermittent, and there is a consequent risk of the battery pack losing its charge in the absence of sufficiently strong wind to sustain propulsion. If the situation persists, external assistance may be required for the boat. A similar situation may arise for a boat powered solely by electricity.

To remedy this drawback, it is desirable to increase the capacity of the batteries carried on the boat, which inevitably leads to an increase in mass and, most importantly, in the volume occupied by all the batteries, as space is already a constraining parameter when designing a vessel.

In addition, the useful power supplied by the battery pack is, in the state of the art, virtually constant and non-controllable, which means that there is no possible prioritization for a boat's skipper between allocating electrical power to functions essential to navigation and to mainly comfort functions, e.g. for passengers.

Lastly, battery charging operations, particularly when docked in a port, require an electrical grid connection infrastructure close to the boat, which limits the number of possible stopping places for an electrical energy supply, for example during long-distance delivery operations.

The invention thus aims to at least partially remedy these shortcomings of the prior art.

### SUMMARY OF THE INVENTION

More precisely, the subject-matter of the invention is the installation of extractable batteries, in particular by proposing a boat comprising:
a hull;
a casing wherein a plurality of racks are arranged;
a plurality of extractable batteries adapted to be plugged into the racks of the casing;
a control module configured to control the supply of electrical equipment on the boat from the batteries;
   the batteries of the plurality of batteries being controlled to supply power to the electrical equipment sequentially, one after the other, or in combination, with several batteries supplying power simultaneously, according to an operating mode selectable from an economical operating mode, a maneuvering operating mode, and a supercharged operating mode.

The boat further comprises a keel located under the hull, the casing being watertight and contained within the keel, the racks being vertical and extending into a volume of the keel. The boat further comprises a retractable hatch allowing access to the watertight casing from inside the boat, the batteries of the plurality of batteries being elongated and adapted to be plugged into the racks of the watertight casing.

Thanks to such a combination of features, such a plurality of batteries enables a user to replace a discharged battery with a charged one, or a faulty battery with a functional one. This means that all batteries can be charged remotely, extending the range of possible locations for refueling during a trip. In addition, such a control module makes it possible to control the electrical power supplied by the plurality of batteries, depending on the chosen operating mode and the current charge of the batteries.

In such a configuration, the plurality of batteries and the racks help to stabilize the boat by contributing to the keel ballast, in the part also known as the keel fin, particularly in the case of a monohull boat such as a sailboat, enabling the center of gravity of said sailboat to be lowered to increase its stiffness to the canvas. In addition, when the batteries are placed in the volume enclosed by the submerged parts of the boat, known as the “underwater hull”, a heat flow circulates between the batteries and the water through the living works of the boat, to cool the batteries and guarantee operation in optimum conditions.

In the economical operating mode, electrical power is mainly supplied sequentially, battery by battery. The control module also prioritizes the allocation of power to electrical equipment essential to navigation, including at least the electric motor in the case of an electrically propelled boat, for example, and guaranteeing the supply of electrical power to instruments for measuring navigation conditions, such as a GPS receiver, or communication instruments, such as a very high frequency radio transponder.

In the maneuvering mode, electrical power is supplied sequentially, battery by battery, or in combination, depending on the mechanical power the electric motor needs to produce, for example in an emergency maneuver, to produce a high mechanical torque to avoid an obstacle. Essential electrical equipment is also powered in maneuvering mode.

In the supercharged operating mode, electrical power is mainly supplied in combination by several of the plurality of batteries, to supply, in addition to the electric motor and essential electrical equipment, non-essential electrical equipment mainly for passenger comfort, such as an electric resistor of a thermodynamic water heater.

The selection of an operating mode by a user allows optimal matching of electrical energy consumption to the need for a given use. In addition, in all three operating modes, the extractable batteries can each be temporarily operated on a boosted state, that is, a state wherein each battery can temporarily deliver more power than its rated output.

What's more, such extractable batteries can be removed when no crew member is on board, preventing attempted theft using the boat's motor. The batteries are preferably removed manually, without tools.

Advantageously, all the batteries in the plurality of batteries are identical. In such a configuration, each battery can be interchanged indiscriminately, and the boat's electrical network as a whole adopts the same behavior in a sequenced battery use mode. Preferably, the plurality of batteries comprises at least 4 batteries, each battery having a storage capacity of preferably between 0.5 kWh and 3 kWh. Each battery preferably weighs between 7.5 kg and 20 kg, so that it can be removed and transported by a single user.

Advantageously, the batteries are elongate and arranged longitudinally in the racks. In this configuration, the casing is accessible from inside the boat, for example in a hold of the boat. The batteries are then removed from the racks by a horizontal longitudinal movement. The casing can advantageously be positioned according to various arrangements of the boat's hold, so as to ballast, for example, the bow or stern of the boat and modify the boat's longitudinal trim angle.

Advantageously, the boat comprises a selector for switching to the next battery when one battery is out of charge. This way, when the batteries are used sequentially, the operation of switching from a charged battery to a discharged battery is carried out without interrupting the power supply to the electrical equipment for a given operating mode.

Advantageously, the selector is manual or automatic. Preferably, the selector is located close to the helm station, so that the boat's helmsman can manually select the battery or batteries available, and decide which operating mode to engage.

Advantageously, the boat comprises a visual indicator of the charge level of the battery(-ies) in use.

Advantageously, the boat comprises a level indicator for each of the batteries.

Advantageously, the boat comprises at least one reserve battery.

Advantageously, the electrical equipment comprises at least one electric motor. In this configuration, the motor rotates a propeller to generate thrust to propel the boat. In particular, the motor and propeller can be contained within the volume of the keel.

Advantageously, the electric motor is reversible to operate as a generator. In such a configuration, the generator transforms mechanical energy from propeller rotation into electrical energy to charge the plurality of batteries, particularly during a sailing phase on a sailboat. The batteries then have an additional operating mode, termed the recharging mode.

According to another aspect of the invention, it relates to a method of using a boat as described above, comprising the determination by a user of an operating mode selectable from an economical operating mode, a maneuvering operating mode and a supercharged operating mode; the method further comprising the powering of electrical equipment by a plurality of batteries sequentially, one after the other, or in combination depending on the operating mode selected.

Of course, in addition to extractable batteries, as briefly described above, the boat may comprise batteries not configured to be extractable. In such a case, only some of the batteries installed on the boat are configured to be extractable and recharged after being transported off the boat.

### BRIEF DESCRIPTION OF THE DRAWINGS

The invention will be better understood upon reading the following description, given by way of example, and referring to the following figures, given as non-limiting examples, wherein identical references are given to similar objects, and wherein:

FIG. 1 is a schematic representation of a boat according to a first embodiment of the invention.

FIG. 2 is a schematic isometric perspective representation of a boat keel in the same embodiment.

It should be noted that the figures set forth the invention in detail to implement the invention; although non-limiting, said figures of course being capable of being used to further define the invention where appropriate.

### DETAILED DESCRIPTION OF THE INVENTION

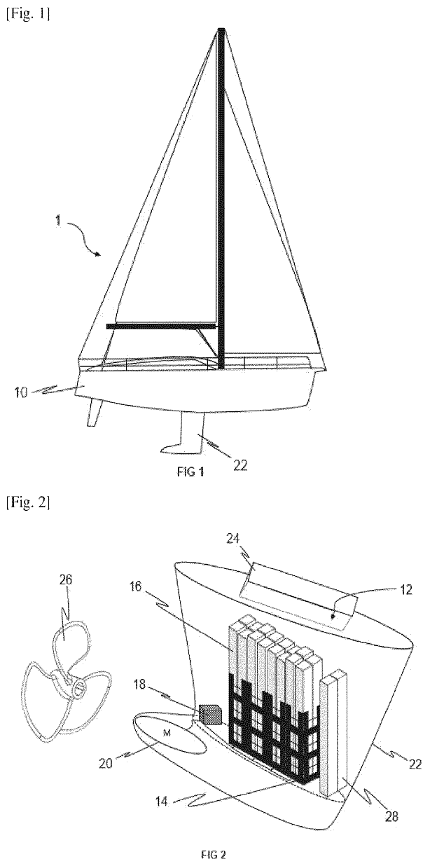

FIGS. 1 and 2 show a boat 1 according to one embodiment of the invention. The boat 1 here is a monohull sailing boat, but can alternatively be a motorboat such as a yacht or speedboat.

The boat 1 comprises a hull 10 configured to ensure the buoyancy of the boat 1 and whose external walls are in contact with water. The hull 10 delimits an interior volume of the boat 1 comprising a hold accessible from the deck of the boat 1 and a keel 22 accessible from the hold. In the case of a motorboat, the keel 22 designates the lowest axial part of the hull 10. Here, the keel 22 projects axially below the hull 22 and has the general shape of a fin. The keel 22 delimits an interior volume accessible from the hold via a retractable hatch 24.

In the embodiment shown, the inner volume of the keel 22 contains a watertight casing 12, wherein vertical racks 14 extend, to which a plurality of batteries 16 are connected, extractable from the racks 14. The batteries 16 are preferably prismatic parallelepipedal in shape, that is, the height of a battery 16 is significantly greater than the dimensions of a base section of said battery 16. All the batteries 16 are identical. Where they are placed in the racks 14 does not matter. The electrical network thus adopts the same behavior in a sequenced mode of use of batteries 16. Each battery 16 preferably has a storage capacity of between 0.5 kWh and 3 kWh. Each battery 16 preferably weighs between 7.5 kg and 20 kg, so that it can be removed and transported by a single user. Such extractable batteries 16 can be removed when no crew member is on board, preventing attempted theft using the boat's motor. The batteries 16 can be extracted manually, without tools, disconnecting from the racks when the physical contact between a battery 16 and its associated rack 14 is broken. The casing 12 further comprises reserve batteries 28 disconnected from the racks 14 for back-up replacement, in the event, for example, of a malfunction observed by a battery 16 during a trip. This means that all batteries can also be charged remotely from the boat, extending the range of possible locations for refueling during a trip.

The plurality of batteries 16 is controlled by a control module 18 to power electrical equipment 20 on the boat 1. The control module 18 is located in the casing 12, in the immediate vicinity of the racks 14.

The batteries 16 are controlled to supply power to the electrical equipment 20 sequentially, one after the other, or in combination, with several batteries 16 supplying power simultaneously, according to an operating mode selectable from an economical operating mode, a maneuvering operating mode, and a supercharged operating mode.

In the economical operating mode, electrical power is supplied sequentially, battery 16 by battery 16. The control module 18 also prioritizes the allocation of power to electrical equipment 20 essential to navigation, including at least one electric motor to drive a propeller 26 in the case of an electrically propelled boat, and guaranteeing the supply of electrical power to instruments for measuring navigation conditions, such as a GPS receiver, or communication instruments, such as a very high frequency radio transponder.

In the maneuvering mode, electrical power is particularly supplied sequentially, battery 16 by battery 16, or in combination, depending on the mechanical power the electric motor 20 needs to produce, for example in an emergency maneuver, to produce a high mechanical torque to avoid an obstacle. Essential electrical equipment is also powered in maneuvering mode.

In the supercharged operating mode, electrical power is mainly supplied in combination by the plurality of batteries 16, to supply, in addition to the electric motor 20 and essential electrical equipment, non-essential electrical equipment (not shown) mainly for passenger comfort, such as an electric resistor of a thermodynamic water heater.

By being placed in the volume enclosed by the submerged parts of the boat, known as the “underwater hull”, a heat flow circulates between the batteries 16 and the water through the living works of the boat, to cool the batteries 16 and guarantee operation in optimum conditions.

In the embodiment described, the plurality of batteries 16 and the racks 14 help stabilize the boat 1 by acting as ballast in the keel, also known as the centerboard, particularly in the case of a monohull boat such as a sailboat, lowering the center of gravity of the boat 1 to increase its stiffness under sail. Stiffness under sail is defined as the vertical distance separating the center of gravity of the points where the forces exerted by the winds on each of the sails apply, referred to as the sail center, from the center of gravity of those points due to the pressure of the water on the underwater parts of the boat 1, and the forces generated by the movement of the boat 1 in the water due to the underwater parts behaving like a profile in a fluid flow.

The control module 18 is connected to a selector switch (not shown), preferably located close to the boat's helm station, so that the boat's helmsman can manually select the battery(-ies) available, and decide which operating mode to engage. The selector defaults to an at least partially charged battery 16 when one of the batteries currently in use falls below a critical discharge threshold, e.g. 3% of its rated capacity. The control module 18 ensures combined use of the batteries 16, even transiently within sequential use, so as to guarantee continuity of the power supply to the electrical equipment 20. The control module 18 is also connected to a level indicator (not shown) for each of the batteries 16, the level indicator being visible to the helmsman of the boat 1 from the helm station.

It should also be noted that the invention is not limited to the embodiments described above. Indeed, it will become apparent to the person skilled in the art that various modifications can be made to the above-described embodiment, in the light of the teachings just disclosed.

For example, the electric motor 20 is reversible to operate as a generator. In such a configuration, the generator 20 transforms mechanical energy from the rotation of the propeller 26 when the boat 1 moves into electrical energy to charge the plurality of batteries, particularly during a sailing phase. The batteries 16 then have an additional operating mode, termed the recharging mode.

According to another embodiment (not shown), the batteries 16 are elongate and arranged longitudinally in the racks 14 of the casing 12. In this configuration, the casing 12 is arranged directly in the hold of the boat 1. The batteries 16 are then removed from the racks 14 by a horizontal longitudinal movement. The casing 12 can advantageously be positioned according to various arrangements of the hold of the boat 1, so as to ballast, for example, the bow or stern of the boat, or to modify the boat's longitudinal trim angle. If, for example, the casing 12 is positioned towards the stern of the boat 1, the vertical distance between the waterline and the lowest point of the hull at the stern, referred to as the aft draft, is greater than the vertical distance between the waterline and the lowest point of the hull at the bow, referred to as the forward draft. In this configuration, the boat's longitudinal trim angle is increased, which improves its maneuverability and seakeeping, for example in adverse weather conditions.

In the detailed presentation of the invention given above, the terms used should not be interpreted as limiting the invention to the embodiment set out in the present description, but should be construed to include all equivalents the anticipation of which is within the abilities of the person skilled in the art by applying his general knowledge to the implementation of the teaching just disclosed to them.

1-10. (canceled)

11. A boat comprising:
a hull;
a casing wherein a plurality of racks are arranged;
a plurality of extractable batteries adapted to be plugged into the racks of the casing;
a control module configured to control the supply of electrical equipment on the boat from the batteries;
the batteries of the plurality of batteries being controlled to supply power to the electrical equipment sequentially, one after the other, or in combination, with several batteries supplying power simultaneously, according to an operating mode selectable from an economical operating mode, a maneuvering operating mode, and a supercharged operating mode,
the boat comprising a keel located under the hull, the casing being watertight and contained within the keel, the racks being vertical and extending into a volume of the keel, the boat further comprising a retractable hatch allowing access to the watertight casing from inside the boat, the batteries of the plurality of batteries being elongated and adapted to be plugged into the racks of the watertight casing.

12. The boat according to claim 11, wherein all batteries of the plurality of batteries are identical.

13. The boat according to claim 11, wherein the batteries are elongate and arranged longitudinally in the racks.

14. The boat according to claim 11, comprising a selector switch for switching to the next battery when one battery is out of charge.

15. The boat according to claim 14, the selector being manual or automatic.

16. The boat according to claim 11, comprising a visual indicator of the charge level of the battery or batteries during use.

17. The boat according to claim 11, comprising a level indicator for each of the batteries.

18. The boat according to claim 11 comprising at least one reserve battery.

19. The boat according to claim 11, wherein the electrical equipment comprises at least one electric motor.

20. A method for operating a boat according to claim 11, comprising the determination by a user of an operating mode selectable from an economical operating mode, a maneuvering operating mode and a supercharged operating mode; the method further comprising the powering of electrical equipment by a plurality of batteries sequentially, one after the other, or in combination depending on the operating mode selected.
